(19) United States
(12) Patent Application Publication
(10) Pub. No.: US 2018/0050894 A1
(43) Pub. Date: Feb. 22, 2018

(54) LIFTING APPLIANCE AND METHOD FOR USING SUCH A LIFTING APPLIANCE

(71) Applicant: HAULOTTE GROUP, L'Horme (FR)

(72) Inventors: Christian DEVAUX, Saint Etienne (FR); Thierry GRANJON, MESSIMY (FR)

(21) Appl. No.: 15/565,931

(22) PCT Filed: Apr. 13, 2016
(86) PCT No.: PCT/EP2016/058124

§ 371 Date: Oct. 12, 2017

(30) Foreign Application Priority Data
Apr. 14, 2015 (FR) 1553262

(51) Int. Cl. B66F 17/00; B66F 11/04

(52) U.S. Cl. CPC B66F 17/006; B66F 11/04

(57) ABSTRACT

The invention relates to a lifting appliance which includes a frame (3), wheels (9) mounted on axles (30) of the frame (3), each wheel (9) including a rim (90) having a radial web (92) attached to a rotary element (342) at one of the ends (32) of one of the axles (30), a load support and means for raising the load support. The radial webs (92) of the rims (90) are axially offset towards one (95) of the side edges (94, 95) of the wheels (9) relative to a median plane (P9) of each wheel (9). The wheels (9) are suitable for being mounted on the axles (30) in a first position, corresponding to a usage configuration of the lifting platform in which the median planes (P9) are separated from the frame (3), and in a second position, corresponding to a transport configuration of the lifting platform, in which the median planes (P9) are moved closer to the frame (3). The lifting appliance includes means for signalling the mounting position of the wheels (9) and/or means for limiting the raising of the load support when the wheels (9) are in the second position thereof. The invention also relates to a method for using such a lifting appliance, for example such as a lifting platform (1) supporting a pod (5) mounted on an articulated arm (7).

The invention relates to a lifting appliance and a method for using such a lifting appliance.

Personal moving lifting platforms generally include a frame on which wheels, a pod and means for raising the pod are mounted. Such lifting platforms must be transported from one worksite to another by road. To that end, their width must not exceed 2.50 m so as not to require an extra long load. Furthermore, such lifting platforms must sometimes be transported by sea, in particular inside a container. However, the standard dimensions of a container are generally smaller than 2.50 m. It is therefore necessary to limit the maximum width of the lifting platform specifically for transport in a container. This amounts to reducing the track width, i.e., the transverse distance between the wheels on each side of the frame of the lifting platform. This solution is not satisfactory, since the track width is an important parameter for the stability of the lifting platform, and therefore for its usage performance and safety. In order to maintain the stability by reducing the track width, an additional weight can be added, but this solution is impractical and expensive.

The same problem also arises for lifting appliances other than lifting platforms, such as lifting trolleys.

It is also known to replace the normal wheels with narrower metal wheels, or casters. However, these casters are thrown away after use, which involves a substantial excess cost. Furthermore, if the lifting platform is used without having replaced the casters with normal wheels, the stability and safety performance of the lifting platform suffer, and a tipping risk arises.

The invention aims to resolve these drawbacks by proposing a new lifting appliance, the dimensions of which can be adapted simply for transport by container, while guaranteeing its usage performance and safety.

To that end, the invention relates to a lifting appliance which comprises a frame, wheels mounted on axles of the frame, each wheel comprising a rim comprising a radial web attached to a rotary element at one of the ends of one of the axles, a load support and means for raising the load support. This lifting appliance is characterized in that the radial webs of the rims are axially offset towards one of the side edges of the wheels relative to a median plane of each wheel, in that the wheels are suitable for being mounted on the axles in a first position, corresponding to a usage configuration of the lifting platform in which the median planes are remote from the frame, and in a second position, corresponding to a transport configuration of the lifting platform, in which the median planes are moved closer to the frame, and in that the lifting appliance comprises means for signaling the mounting position of the wheels and/or means for limiting the raising of the load support when the wheels are in the second position thereof.

Owing to the structure and the two possibilities for mounting the wheels, the width of the lifting appliance can be reduced for transport in a container, while the performance and usage stability are guaranteed when the wheels are mounted in their usage configuration. The presence of signaling means for the mounting position of the wheels and/or means for limiting the raising of the load support when the wheels are in their second position makes it possible to secure the use of the lifting appliance.

According to advantageous, but optional aspects of the invention, such a lifting appliance may incorporate one or more of the following features, considered in any technically allowable combination:
The radial web is situated at a distance from the side edge of the wheel to which it is closest corresponding to a value comprised between 10 and 40% of the total width of the wheel.
The means for signaling the mounting position of the wheels comprise distinctive signs visible from the sides of the lifting appliance.
The means for limiting the raising of the load support when the wheels are in their second mounting position are suitable for preventing the raising of the load support by a height corresponding to 30% of the maximum lifting height.
The means for limiting the raising of the load support comprise a program integrated into a control unit of the lifting appliance.
The program is suitable for being deactivated by entering a code when the lifting appliance must be placed in the usage configuration.
The means for limiting the raising of the load support comprise at least one strap passing over the lifting means and the ends of which are fastened on the axles such that the strap cannot be removed without disassembling the wheels.
The appliance comprises two pairs of wheels, the means limiting the raising of the load support comprising two straps crossed over the lifting means.
Each strap comprises, at each of its ends, a loop having a perimeter smaller than the perimeter of the wheels.

The invention also relates to a method for using a lifting appliance as described above. This method is characterized in that it comprises, when the lifting appliance must be taken from its transport configuration to its usage configuration, the steps consisting of disassembling the wheels, deactivating or disassembling the means for limiting the raising of the load support when the wheels are in their second mounting position, and remounting the wheels in their first mounting position.

The invention will be better understood, and other advantages thereof will appear more clearly, in light of the following description of a lifting appliance and a method for using a lifting appliance according to its principle, provided as a non-limiting example in reference to the appended drawings, in which:

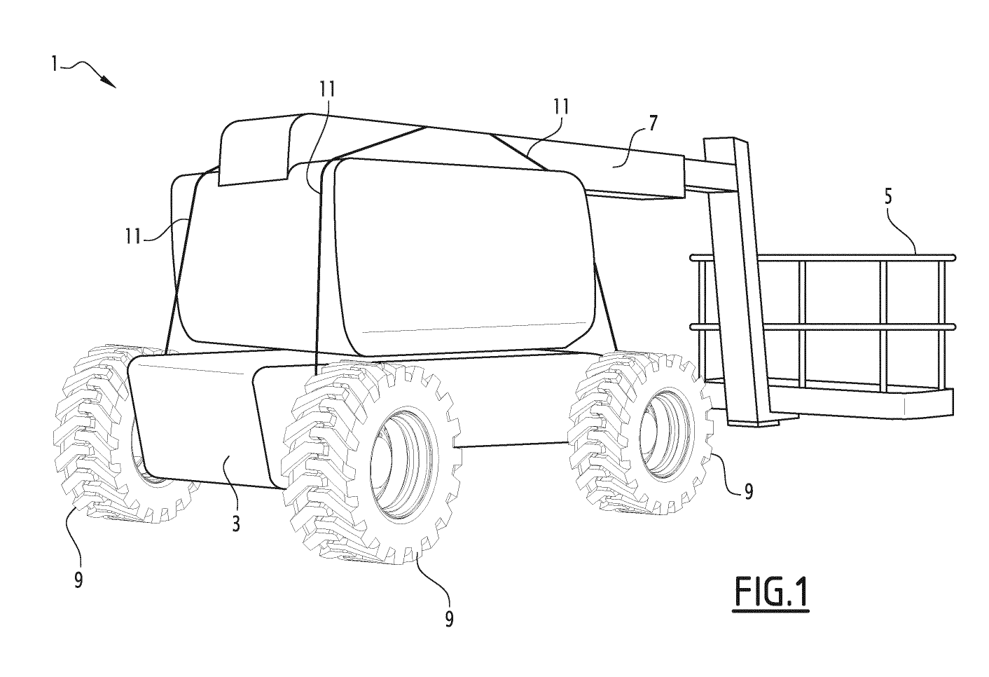

FIG. 1 is a perspective view of a lifting platform according to the invention;

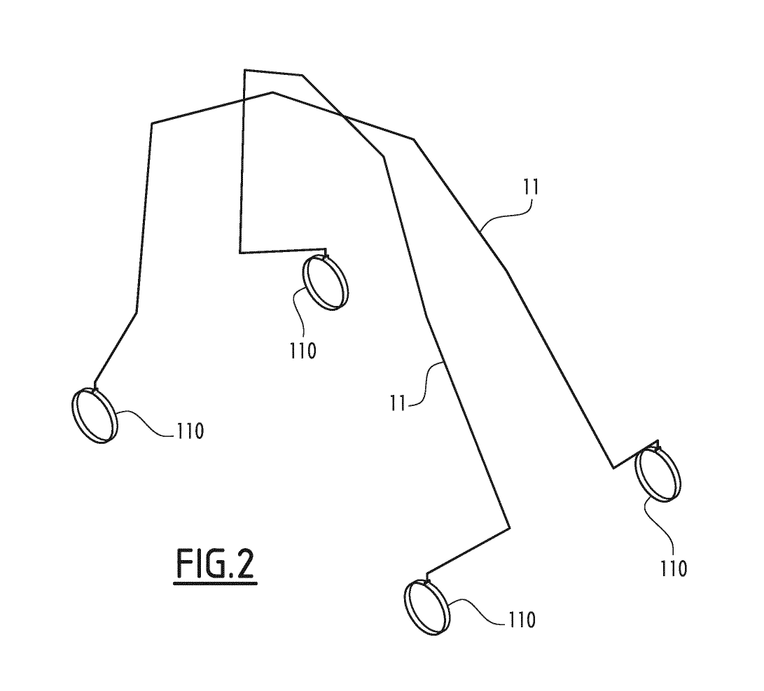

FIG. 2 is a schematic perspective view of a system for limiting the raising of the pod of the lifting platform of FIG. 1;

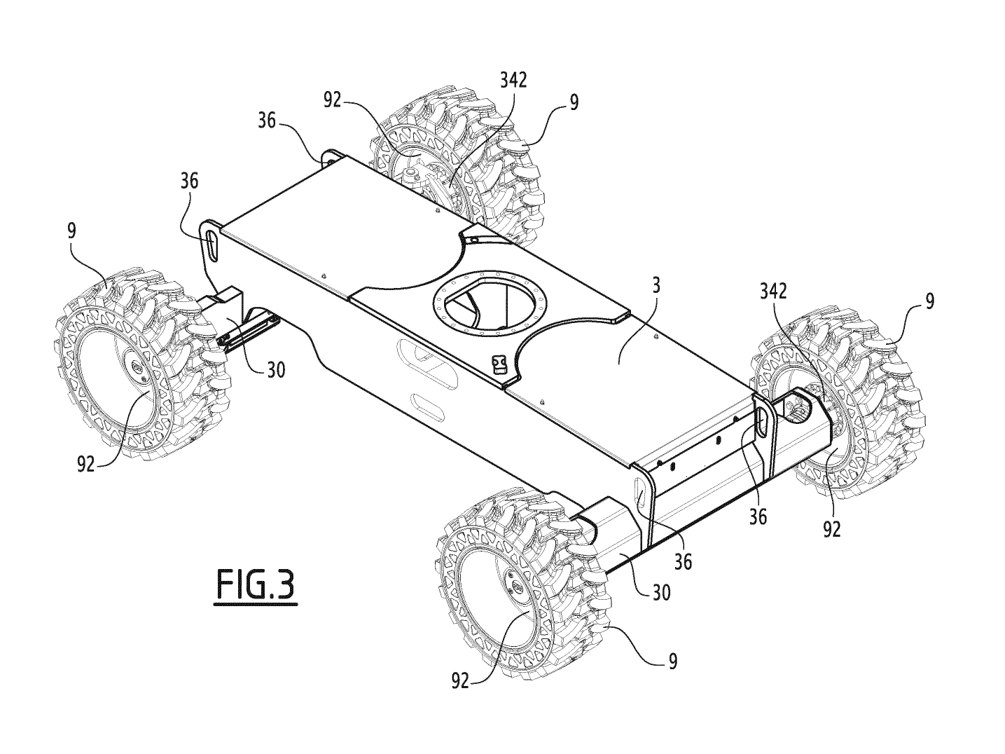

FIG. 3 is a perspective view of a frame of the lifting platform of FIG. 2, in a usage configuration of the lifting platform.

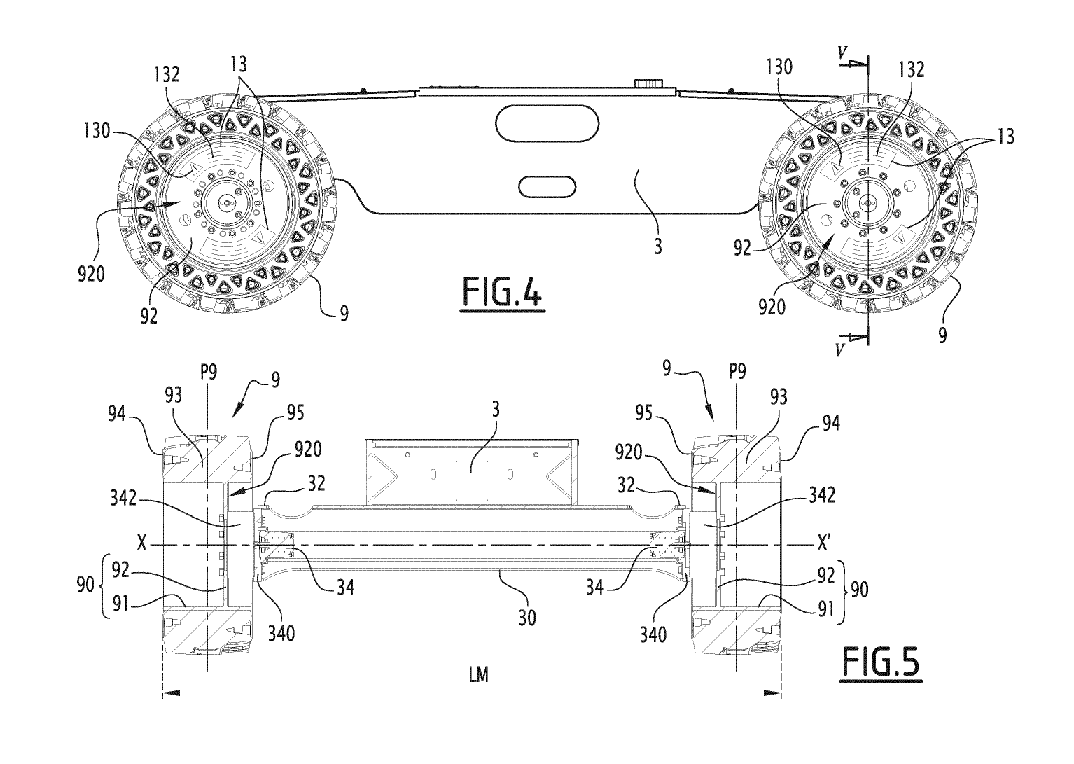

FIG. 4 is a side view of the frame of FIG. 3, in a transport configuration of the lifting platform;

FIG. 5 is a sectional view along plane V-V in FIG. 4, of the frame of FIGS. 3 and 4, in the usage configuration;

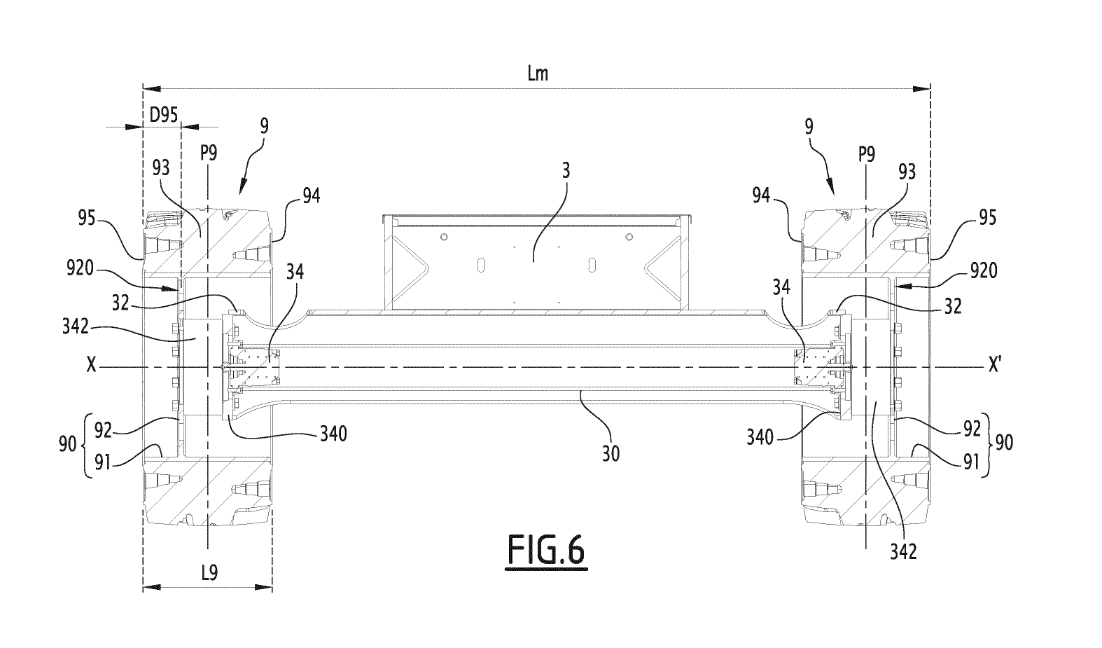

FIG. 6 is a sectional view similar to FIG. 5, in the transport configuration.

FIG. 1 shows a lifting appliance, a lifting platform 1 in this example, comprising a frame 3, a load support formed by a pod 5 and means for raising the pod 5 formed by an articulated arm 7.

The platform 1 comprises two wheels 9 mounted on axles 30 belonging to the frame 3. The axles 30 are hollow and fastened non-rotatably on the frame 3. Hydraulic motors 34 are fastened to the inside of the axles 30 at the ends 32 of the axles 30. The hydraulic motors 34 comprise output shaft 340 that define rotation axes X-X′ of the wheels 9. The wheels 9 are mounted on the output axes 340 via reduction gears 342. The output shafts 340 and the reduction gears 342 form rotary elements secured to the axles 30, and on which the wheels 9 are mounted. The rotation axes X-X′ define the transverse direction of the lifting platform 1.

In the present description, the terms “radial”, “axial”, “axially” and “radially” are used in reference to the rotation axes X-X′.

Each wheel 9 comprises a rim 90 having an axial part 91 on which a tire 93 is mounted, and a radial web 92 extending inside the axial part 91 and that is fastened on a reduction gear 342.

The wheels 9 have two side edges 94 and 95. According to the invention, the radial webs 92 are axially offset toward the side edge 95 of the wheels 9 relative to a median plane P9 of each wheel 9. The median planes P9 extend at equal distances from the edges 94 and 95 of the wheels 9 and perpendicular to the rotation axes X-X′ of the wheels 9.

Owing to the geometric structure of the rims 90, the wheels 9 are suitable for being mounted on the axles 30 in a first position, shown in FIG. 5, corresponding to an operating configuration of the lifting platform 1. In this configuration, the edges 95 are situated toward an inner side of the wheels 9 and the median planes P9 are moved away from the frame 3 such that the platform 1 has its maximum width LM in this configuration. This operating configuration allows the greatest stability of the platform 1.

The wheels 9 are suitable for being mounted on the axles 30 in a second position, shown in FIG. 6, corresponding to a transport configuration of the lifting platform 1. In this configuration, the side edges 95 are situated on the outer side of the wheels 9, opposite the frame 3, and the median planes P9 are moved closer to the frame 3 such that the ends 32 of the axles 30 are engaged in the wheels 9 more substantially than in the operating configuration. Indeed, in FIG. 6, the planes P9 pass in the reduction gears 342, such that in FIG. 5, in the usage configuration, the planes P9 pass axially beyond the reduction gears 342 toward the outside. In this transport configuration, the platform 1 has a minimal width Lm smaller than the maximum width LM.

Preferably, for each wheel 9, the radial web 92 is situated at a distance D95 from the side edge of the wheel 9 to which it is closest, i.e., the side edge 95, corresponding to a value comprised between 10 and 40% of the total width L61 of the wheel 9.

According to the invention, the lifting platform 1 also comprises means for signaling the mounting position of the wheels 9 and/or means for limiting the raising of the pod 5 when the wheels 9 are in their second mounting position.

In the illustrated example, the platform 1 comprises means for limiting the raising of the pod when the wheels 9 are in their position of FIG. 6. Indeed, when the wheels 9 are in their position of FIG. 6, the width of the lifting platform 1 is reduced, which causes a reduction in the stability of the lifting platform 1 when the pod 5 is raised. In order to limit the raising of the pod 5, the lifting platform 1 comprises straps 11 passing over the raising means 7, and the ends 110 of which are fastened on the axles 30 such that the straps 11 cannot be removed without first disassembling the wheels 9.

The ends 110 comprise loops, the perimeter of which is smaller than the perimeter of the wheels 9, which means that the wheels 9 must be disassembled, then the straps 11 removed, before the raising means 7 for the pod 5 can be actuated.

Preferably, the means for limiting the raising of the pod 5 when the wheels 9 are in their second mounting position are suitable for preventing the raising of the pod 5 by a height corresponding to 30% of the maximum raising height. In this way, the maximum raising height remains within the stability limits allowed by the transport configuration, which increases the usage safety of the lifting platform 1.

Optionally, the frame 3 comprises orifices 36 for the guiding and passage of the straps 11 facilitating their mounting on the axles 30.

The method for using the lifting platform 1 is described below. In an initial transport configuration, the pod 5 is in a low position and the wheels 9 are mounted in their second position, in the transport configuration of the lifting pod 1. Before mounting the wheels in the transport configuration, the straps 11 have been placed by passing the loops of the ends 110 over the axles such that the straps 11 intersect on the raising means 7, making it impossible to raise the pod 5.

When the lifting platform 1 must be used, the wheels 9 are disassembled beforehand. Next, the straps 11 are removed from the axles 30. The wheels 9 are next remounted on the axles 30 in their first position, to obtain the usage configuration of the lifting platform 1.

According to one alternative of the invention that is not shown, the lifting appliance 1 may comprise only one strap 11.

In the illustrated example, the lifting platform 1 also comprises means 13 for signaling the mounting position of the wheels 9, shown in FIG. 4. These signaling means 13 comprise distinctive signs provided on the wheels 9 and visible from the sides of the lifting platform 1 when the wheels 9 are in their second mounting position. The signaling means 13 are preferably provided on one side 920 of the radial webs 92 oriented toward the side edge 95, i.e., on the side of the side edge that is toward the outside when the wheels 9 are in their second mounting position. These distinctive signs for example comprise warning signals 130 making it possible to signal that the wheels 9 are mounted in their position corresponding to the transport configuration. The signaling means 13 can also comprise warning phrases 132 signaling the need to change the mounting of the wheels 9 before any normal use of the platform 1.

Optionally, the signaling means 13 can comprise reflective parts.

According to one embodiment of the invention that is not shown, the means for limiting the raising of the pod 5 can comprise a program integrated into a control unit of the lifting platform 1. This program can be suitable for being deactivated by entering a code when the lifting platform 1 must be placed in the usage configuration. The code may in particular be entered by qualified personnel upon delivery of the lifting platform 1.

According to another embodiment of the invention that is not shown, the lifting platform 1 may comprise only means for limiting the raising of the pod 5, or only means for signaling the mounting position of the wheels 9.

According to another embodiment of the invention that is not shown, the wheels 9 may not be rotated by motors and reduction gears, but may simply be mounted rotating on the axles 30. In such a case, the wheels 9 are mounted on rotary elements such as rolling bearings or main bearings.

The invention also applies to other types of lifting appliances, for example lifting trolleys with a pylon, comprising tool assemblies and able to raise persons or goods. In this case, the load support may be different from the pod 5. The raising means may be different from the articulated arm 7.

The technical features of the embodiments and alternatives described above may be combined to form new embodiments of the invention.

1-10. (canceled)

11. A lifting appliance, comprising:
a frame,
wheels mounted on axles of the frame, each wheel comprising a rim comprising a radial web attached to a rotary element at one of the ends of one of the axles,
a load support, and
means for raising the load support,
wherein the radial webs of the rims are axially offset towards one of the side edges of the wheels relative to a median plane of each wheel, wherein the wheels are suitable for being mounted on the axles in a first position, corresponding to a usage configuration of the lifting platform, in which the median planes are remote from the frame, and in a second position, corresponding to a transport configuration of the lifting platform, in which the median planes are moved closer to the frame, and wherein the lifting appliance comprises means for signaling the mounting position of the wheels and/or means for limiting the raising of the load support when the wheels are in the second position thereof.

12. The lifting appliance according to claim 11, wherein the radial web is situated at a distance from the side edge of the wheel to which it is closest, corresponding to a value comprised between 10 and 40% of the total width of the wheel.

13. The lifting appliance according to claim 11, wherein the means for signaling the mounting position of the wheels comprise distinctive signs visible from the sides of the lifting appliance.

14. The lifting appliance according to claim 11, wherein the means for limiting the raising of the load support when the wheels are in their second mounting position are suitable for preventing the raising of the load support by a height corresponding to 30% of the maximum lifting height.

15. The lifting appliance according to claim 11, wherein the means for limiting the raising of the load support comprise a program integrated into a control unit of the lifting appliance.

16. The lifting appliance according to claim 15, wherein the program is suitable for being deactivated by entering a code when the lifting appliance must be placed in the usage configuration.

17. The lifting appliance according to claim 11, wherein the means for limiting the raising of the load support comprise at least one strap passing over the lifting means and the ends of which are fastened on the axles such that the strap cannot be removed without disassembling the wheels.

18. The lifting appliance according to claim 11, wherein it comprises two pairs of wheels, and wherein the means limiting the raising of the load support comprise two straps crossed over the lifting means.

19. The lifting appliance according to claim 17, wherein each strap comprises, at each of its ends, a loop having a perimeter smaller than the perimeter of the wheels.

20. A method for using a lifting appliance according to claim 11, wherein it comprises, when the lifting appliance must be taken from its transport configuration to its usage configuration, the steps consisting of:
disassembling the wheels,
deactivating or disassembling the means for limiting the raising of the load support when the wheels are in their second mounting position,
remounting the wheels in their first mounting position.
